(19) United States
(12) Patent Application Publication
(10) Pub. No.: US 2010/0156323 A1
(43) Pub. Date: Jun. 24, 2010

(54) Light emitting device driver circuit and method for driving light emitting device

(75) Inventors: Chueh-Kuei Jan, Chubei City (TW); Shui-Mu Lin, Taichung City (TW)

Correspondence Address: TUNG & ASSOCIATES / RANDY W. TUNG, ESQ., 838 W. LONG LAKE RD., SUITE 120, BLOOMFIELD HILLS, MI, 48302, US

(73) Assignee: Richtek Technology Corporation

(21) Appl. No.: 12/583,674

(22) Filed: Aug. 25, 2009

(30) Foreign Application Priority Data
Dec. 18, 2008 (TW) 097149513

(51) Int. Cl. H05B 37/02

(52) U.S. Cl. 315/307

(57) ABSTRACT

The present invention discloses a light emitting device driver circuit and a method for driving a light emitting device. The circuit comprises: a power stage performing power conversion on an input voltage to supply an output current to one or more light emitting devices; and a control circuit sensing the output current of the power stage to feedback control the power stage accordingly.

### BACKGROUND OF THE INVENTION

1. Field of Invention

The present invention relates to a light emitting device driver circuit and a method for driving a light emitting device; particularly, it relates to a light emitting diode (LED) driver circuit having better power utilization efficiency and reduced circuit area, and a method for driving LEDs.

2. Description of Related Art

As shown in FIG. 1, a conventional LED driver circuit 10 usually includes a boost power converter 12 which converts an input voltage Vin to an output voltage Vout and supplies it to a light emitting device 2. The LED driver circuit 10 also includes a current source 14 to control the current flowing through the light emitting device 2. The boost power converter 12 usually includes an error amplifier, a comparator, a power switch, an inductor, a switch control logic circuit, etc., which are well known to persons skilled in this art and are thus omitted here.

Such prior art has a drawback that the current source 14 consumes power and circuit area, resulting in efficiency waste.

### SUMMARY OF THE INVENTION

In view of the foregoing drawback, the present invention provides a light emitting device driver circuit with better power utilization efficiency and reduced circuit area, and a method for driving light emitting devices.

To achieve the foregoing objective, in one perspective of the present invention, it provides a light emitting device driver circuit, comprising: a power stage performing power conversion on an input voltage to supply an output current to one or more light emitting devices; and a control circuit sensing the output current of the power stage to feedback control the power stage accordingly.

In another perspective of the present invention, it provides a method for driving a light emitting device, comprising: receiving an input voltage and performing power conversion to provide an output current to one or more light emitting devices; sensing the output current; and controlling the power conversion according to the result of the sensing step.

In the foregoing circuit and method, the power conversion includes one of the followings: buck conversion, boost conversion, buck-boost conversion, and inverter conversion, and the power conversion can be performed by one of the following circuits: a buck power converter, a boost power converter, a buck-boost power converter, an inverter circuit, a fly-back power converter, a linear voltage converter, and a charge pump.

In addition, the light emitting device can be connected in reverse series. In a preferred embodiment wherein the light emitting device is connected in reverse series, the light emitting device has one terminal coupled to the power stage and the other terminal coupled to an input voltage.

The objectives, technical details, features, and effects of the present invention will be better understood with regard to the detailed description of the embodiments below, with reference to the drawings.

### BRIEF DESCRIPTION OF THE DRAWINGS

FIG. 1 is a schematic circuit diagram showing a prior art LED driver circuit.

FIG. 2 is a schematic circuit diagram showing an embodiment of the present invention.

FIGS. 3A-3G illustrate several forms of the power stage.

FIG. 4 is a schematic circuit diagram showing another embodiment of the present invention.

FIG. 5 is a schematic circuit diagram showing yet another embodiment of the present invention.

FIG. 6 shows that the present invention can significantly improve efficiency as compared with the prior art.

### DESCRIPTION OF THE PREFERRED EMBODIMENTS

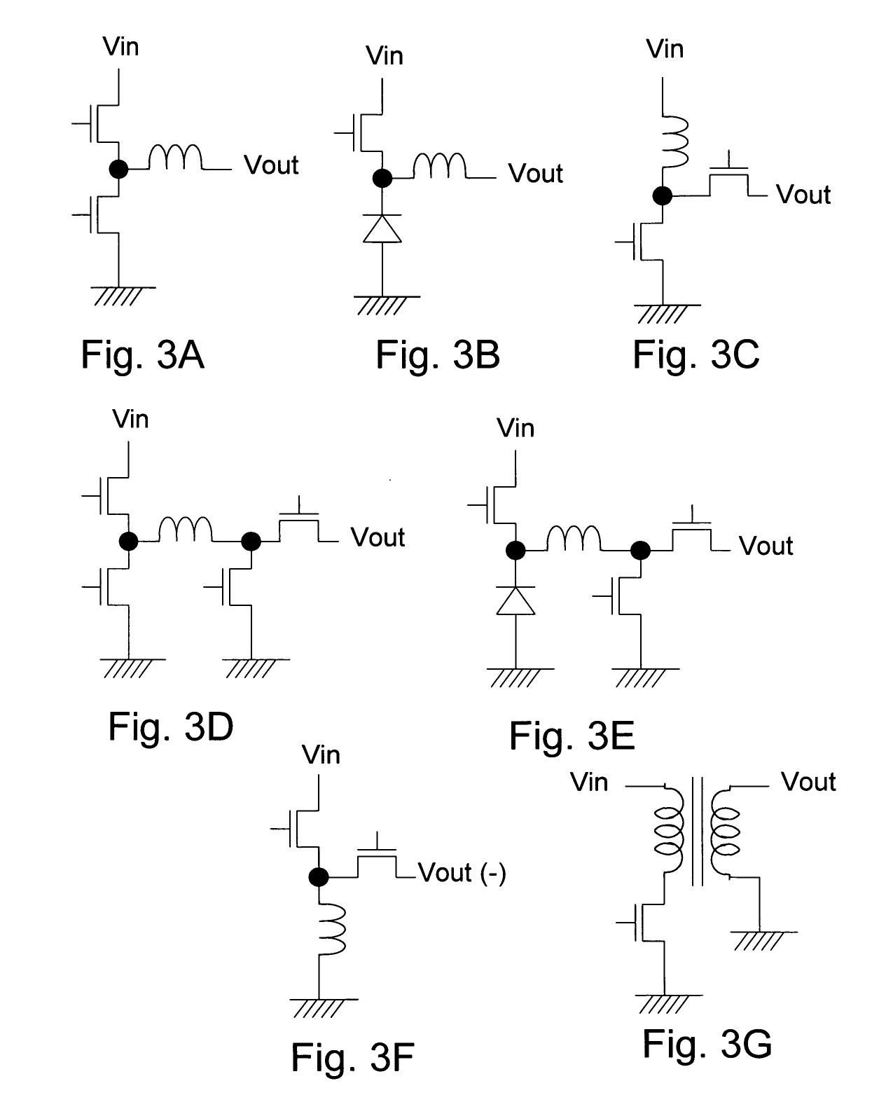

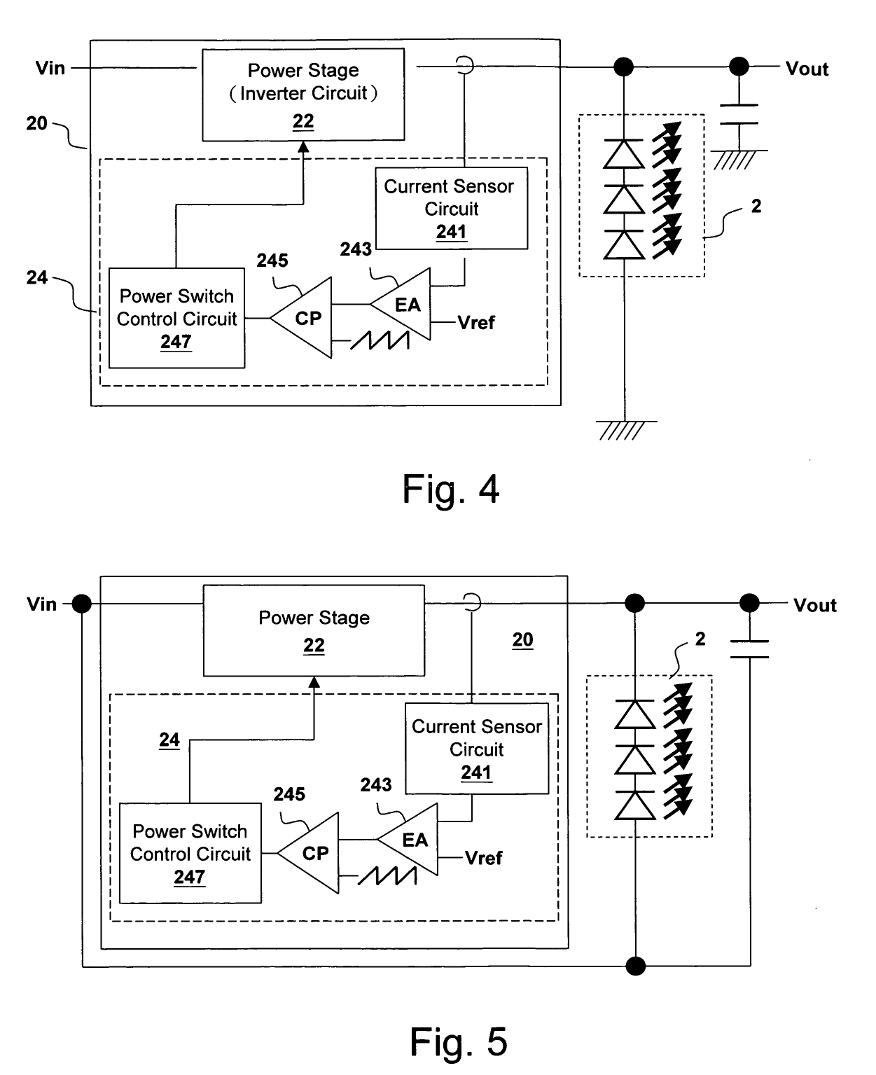

Please refer to FIG. 2, which shows an embodiment of the present invention by a schematic circuit diagram. The light emitting device driver circuit 20 of the present invention includes a power stage 22 and a control circuit 24. The control circuit 24 controls the power stage 22 to convert an input voltage Vin to an output voltage Vout, and supplies the output voltage Vout to a light emitting device 2. The number of LEDs in the light emitting device 2 can be any number as required, and the LEDs can be connected in series, in parallel, or in parallel-series; what is shown in the drawing is only an example. The power stage 22 for example can be one of: a buck power converter, a boost power converter, a buck-boost power converter, an inverter circuit, and a fly-back power converter, as shown in FIGS. 3A-3G. If the power stage 22 is an inverter circuit as shown in FIG. 3F, the LEDs in the light emitting device 2 should be connected in reverse series, as shown in FIG. 4. The present invention is different from the prior art in several aspects: First, the current flowing through the LEDs is not controlled by a current source; hence, the current source is not required and can be omitted to save the circuit area. Second, because the current source is no more required, the overall circuit efficiency is improved. Furthermore, the present invention does not require an external resistor to define the current amount.

More specifically, the control circuit 24 includes a current sensor circuit 241, an error amplifier (EA) 243, a comparator (CP) 245, and a power switch control circuit 247. The current sensor 241 senses an output current of the power stage 22 and converts it to a voltage signal which is inputted to an input terminal of the error amplifier 243. The error amplifier (EA) 243 compares the voltage signal with a reference voltage Vref and generates an error amplified signal according to a difference therebetween, and the error amplified signal is inputted to an input terminal of the comparator 245. The comparator 245 compares the error amplified signal with a saw tooth signal, and the comparison result is transmitted to the power switch control circuit 247. The power switch control circuit controls a power switch in the power stage 22 according to the comparison result.

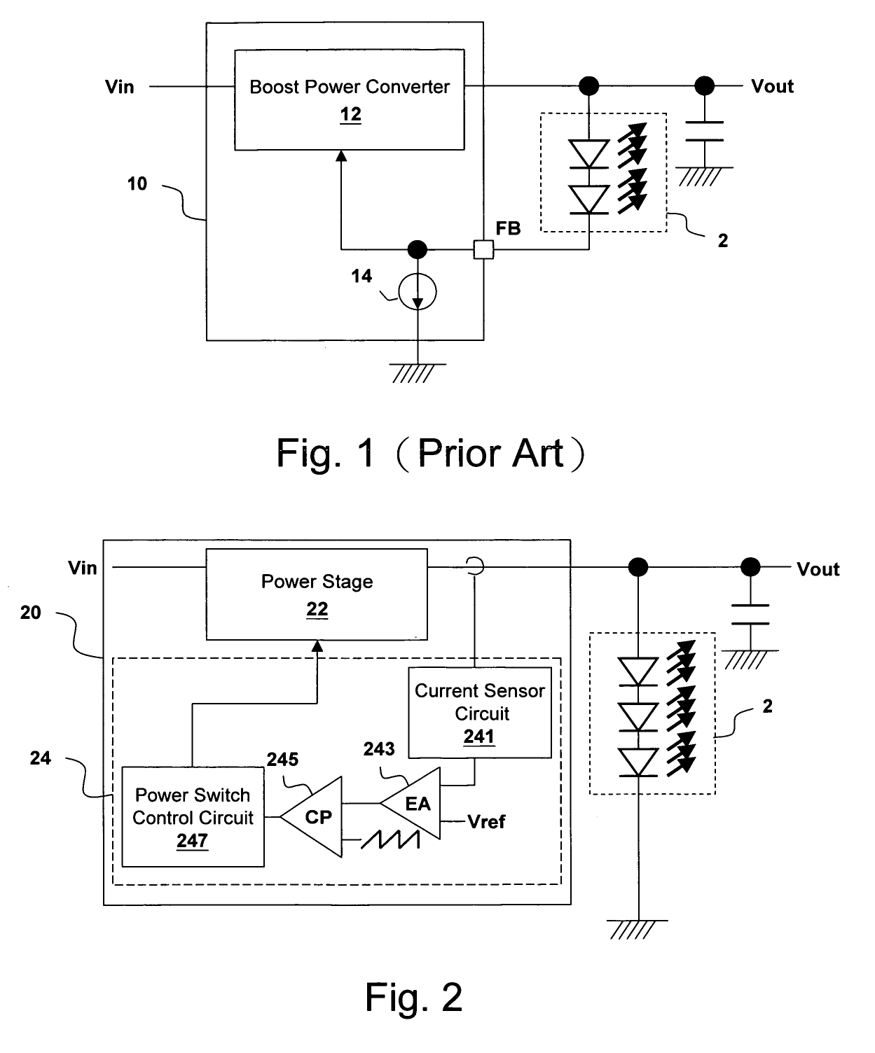

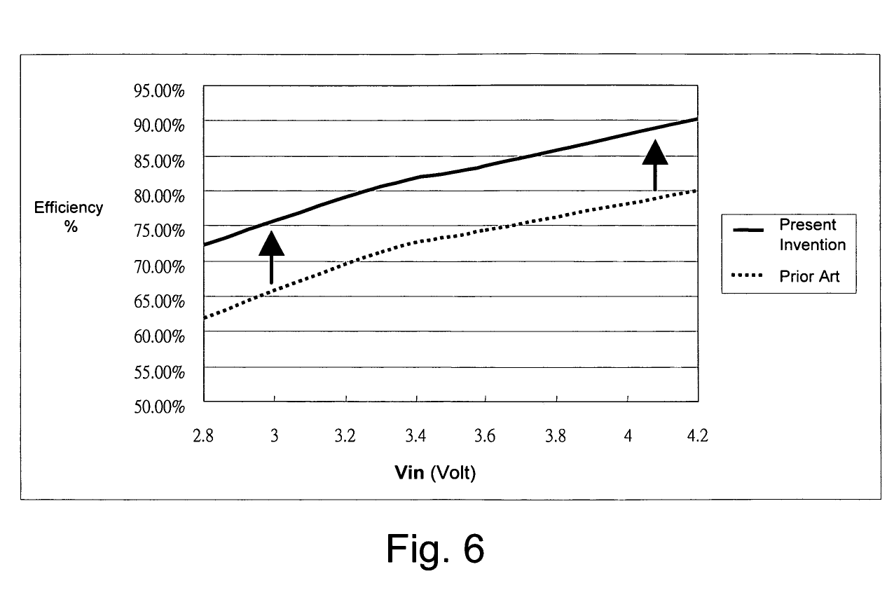

Because feedback control is directly based on the output current of the power stage 22, the current flowing through the LEDs can be controlled within a desired current value, without a current source. In comparison with the prior art shown in FIG. 1, the present invention is not only simpler in circuit structure, but also has better power utilization efficiency. Referring to FIG. 6 wherein the horizontal axis is the input voltage and the vertical axis is the conversion efficiency of the input voltage converted to the LED current, the present invention can improve power utilization efficiency as much as about 10% as shown in the figure.

FIG. 5 shows another embodiment of the present invention. In this embodiment, the lower terminal of the light emitting device 2 and the lower terminal of an output capacitor are not coupled to ground, but coupled to the input voltage Vin. When the power stage 22 is an inverter circuit as shown in FIG. 3F, such connection can enlarge the voltage difference across the light emitting device 2. In other words, it can reduce the loading of the power stage 22.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the power stage 22 can be any power converter circuits other than that shown in FIGS. 3A-3G, such as a linear voltage converter, or a charge pump. As yet another example, an additional circuit device which does not substantially affect the primary function of the circuit can be interposed between two devices shown to be in direct connection in the embodiments of the present invention, such as a switch circuit, a diode circuit, a resistor circuit, or the like. As yet another example, the position to sense the LED current sensor is not limited to the position illustrated in the embodiments; it can be arranged at any other appropriate position. As yet another example, although the circuit is shown for controlling LEDs, the LEDs can be replaced by any other light emitting devices requiring current control, such organic light emitting diodes (OLEDs). In view of the foregoing, the spirit of the present invention should cover all such and other modifications and variations, which should be interpreted to fall within the scope of the following claims and their equivalents.

What is claimed is:

1. A light emitting device driver circuit, comprising:
a power stage performing power conversion on an input voltage to supply an output current to one or more light emitting devices; and
a control circuit sensing the output current of the power stage to feedback control the power stage accordingly.

2. The light emitting device driver circuit of claim 1, wherein the light emitting device includes one or more light emitting diodes (LEDs), or one or more organic light emitting diodes (OLEDs).

3. The light emitting device driver circuit of claim 1, wherein the power stage includes one of the following circuits: a buck power converter, a boost power converter, a buck-boost power converter, an inverter circuit, a fly-back power converter, a linear voltage converter, and a charge pump.

4. The light emitting device driver circuit of claim 1, wherein the control circuit includes:
a current sensor circuit sensing the output current of the power stage;
an error amplifier comparing an output signal of the current sensor circuit with a reference signal and generating an error amplified signal according to a difference between the output signal of the current sensor circuit and the reference signal;
a comparator comparing the error amplified signal with a saw tooth signal; and
a power switch control circuit controlling the power stage according to the comparison result of the comparator.

5. The light emitting device driver circuit of claim 1, wherein the light emitting device has a terminal coupled to the power stage and another terminal coupled to the input voltage.

6. A method for driving a light emitting device, comprising:
receiving an input voltage and performing power conversion to provide an output current to one or more light emitting devices;
sensing the output current; and
controlling the power conversion according to the result of the sensing step.

7. The method of claim 6, wherein the light emitting device includes one or more LEDs, or one or more OLEDs.

8. The method of claim 6, wherein the power conversion includes one of the followings: buck conversion, boost conversion, buck-boost conversion, and inverter conversion.

9. The method of claim 6, wherein the step of controlling the power conversion includes:
comparing the result of the sensing step with a reference signal to generate an error amplified signal;
comparing the error amplified signal to a saw tooth signal; and
controlling the power conversion according to the result of the comparison between the error amplified signal and the saw tooth signal.

10. The method of claim 6 further comprising:
coupling a terminal of the light emitting device to the input voltage.
